(19) United States
(12) Patent Application Publication
(10) Pub. No.: US 2024/0135366 A1
(43) Pub. Date: Apr. 25, 2024

(54) SYSTEM AND METHOD FOR SECURE COMMUNICATIONS THROUGH SECURE CONTRACTS

(71) Applicant: Rogue One Enterprises, Santee, CA (US)

(72) Inventor: Patrick Nunally, Escondido, CA (US)

(73) Assignee: Rogue One Enterprises, Santee, CA (US)

(21) Appl. No.: 18/493,469

(22) Filed: Oct. 23, 2023

Related U.S. Application Data
(60) Provisional application No. 63/380,703, filed on Oct. 24, 2022.

(51) Int. Cl. G06Q 20/38; G06Q 20/02; G06Q 20/36

(52) U.S. Cl. CPC G06Q 20/38215; G06Q 20/02; G06Q 20/3674; G06Q 20/3829

(57) ABSTRACT

A blockchain implemented secure contract communication method to resolve a problem, such as a data breach or compromise of communication between service end points, channels, servers as well as transitional data held in a communication network device.

### CROSS REFERENCE TO RELATED APPLICATIONS

This application claims priority from U.S. Provisional Application Ser. No. 63/380,703, filed Oct. 24, 2022, the entire disclosure of which is incorporated herein by reference.

### BACKGROUND

### Field of the Disclosure

Aspects of the disclosure relate in general to the field of information technologies, and in particular, to a secure ledger communication system, method and apparatus.

### Description of the Related Art

As a branch of the blockchain technology, the consortium blockchain technology is increasingly used. Blockchain nodes in a consortium blockchain network include service nodes and consensus nodes. The service node participates in a service, and the consensus node is responsible for receiving service data sent by the service node and performing consensus verification on the service data.

The previously described service node is a service server of each institution that joins the consortium blockchain network, and software is installed on the server to communicate with another node in the consortium blockchain network (the software is referred to as a “communication program” in the present application).

Different service nodes provide services for different applications (APPs). The service node sends service data generated by the APP to the consensus node for consensus verification. Assuming that a service node is a server corresponding to a catering application, another service node is a server corresponding to a payment application. A user can make a payment through the payment application after making an order through the catering application, as such, the two service nodes can participate in the same service, and can register a service relationship with the consortium blockchain network.

In the consortium blockchain network, each service node stores service data of a service in which the service node participates, and the service data usually includes a user's private data. Based on the existing technology, a more secure communication method is needed.

### SUMMARY

Embodiments include a system, device and method of providing a blockchain implemented secure contract communication to resolve a problem, such as a data breach or compromise of communication between service end points, channels, servers as well as transitional data held in a communication network device.

One embodiment includes a blockchain contract system in a blockchain network. A financial network wallet node configured to receive a communication request comprising a public key certificate of a wallet node of the blockchain network. The financial network wallet mode stores a wallet certificate authority trust list comprising a plurality of certificate authority identifiers. A blockchain network communications node obtains a communications certificate authority trust list. The blockchain network communications node determines whether the communications certificate authority identifier matches one of the plurality of certificate authority identifiers of the communications certificate authority trust list. When the blockchain network communications node determines that the communications certificate authority identifier matches one of the plurality of certificate authority identifiers of the communications certificate authority trust list, the blockchain network communications node approves a communication request. The approval of the communications request comprises: transmitting, by the blockchain network communications node, to the blockchain network wallet a verification request comprising a public key certificate of the communications node; the financial network wallet node verifies a wallet certificate authority identifier from the received public key certificate of the blockchain network communications node; when the wallet certificate authority identifier matches one of the plurality of certificate authority identifiers of the wallet certificate authority trust list of the wallet node, the communications node establishes a communication session.

Another embodiment includes a blockchain contract method. A communication request is received. via a financial network wallet node. The communication request comprises a public key certificate of a wallet node of the blockchain network. The financial network wallet mode stores a wallet certificate authority trust list comprising a plurality of certificate authority identifiers. A blockchain network communications node obtains a communications certificate authority trust list. The blockchain network communications node determines whether the communications certificate authority identifier matches one of the plurality of certificate authority identifiers of the communications certificate authority trust list. When the blockchain network communications node determines that the communications certificate authority identifier matches one of the plurality of certificate authority identifiers of the communications certificate authority trust list, the blockchain network communications node approves a communication request. The approval of the communications request comprises: transmitting, by the blockchain network communications node, to the blockchain network wallet a verification request comprising a public key certificate of the communications node; the financial network wallet node verifies a wallet certificate authority identifier from the received public key certificate of the blockchain network communications node; when the wallet certificate authority identifier matches one of the plurality of certificate authority identifiers of the wallet certificate authority trust list of the wallet node, the communications node establishes a communication session.

Another embodiment includes a non-transitory computer-readable storage medium encoded with data and instructions. When read by a computing device causes a blockchain network to perform a method. A communication request is received. via a financial network wallet node. The communication request comprises a public key certificate of a wallet node of the blockchain network. The financial network wallet mode stores a wallet certificate authority trust list comprising a plurality of certificate authority identifiers. A blockchain network communications node obtains a communications certificate authority trust list. The blockchain network communications node determines whether the communications certificate authority identifier matches one of the plurality of certificate authority identifiers of the communications certificate authority trust list. When the blockchain network communications node determines that the communications certificate authority identifier matches one of the plurality of certificate authority identifiers of the communications certificate authority trust list, the blockchain network communications node approves a communication request. The approval of the communications request comprises: transmitting, by the blockchain network communications node, to the blockchain network wallet a verification request comprising a public key certificate of the communications node; the financial network wallet node verifies a wallet certificate authority identifier from the received public key certificate of the blockchain network communications node; when the wallet certificate authority identifier matches one of the plurality of certificate authority identifiers of the wallet certificate authority trust list of the wallet node, the communications node establishes a communication session.

### BRIEF DESCRIPTION OF THE DRAWINGS

To better understand the nature and advantages of the present disclosure, reference should be made to the following description and the accompanying FIGURES. It is to be understood, however, that each of the FIGURES is provided for the purpose of illustration only and is not intended as a definition of the limits of the scope of the present disclosure. Also, as a general rule, and unless it is evident to the contrary from the description, where elements in different FIGURES use identical reference numbers, the elements are generally either identical or at least similar in function or purpose.

FIG. 1 is a block diagram of illustrating a blockchain node communication process, according to an implementation of the present application.

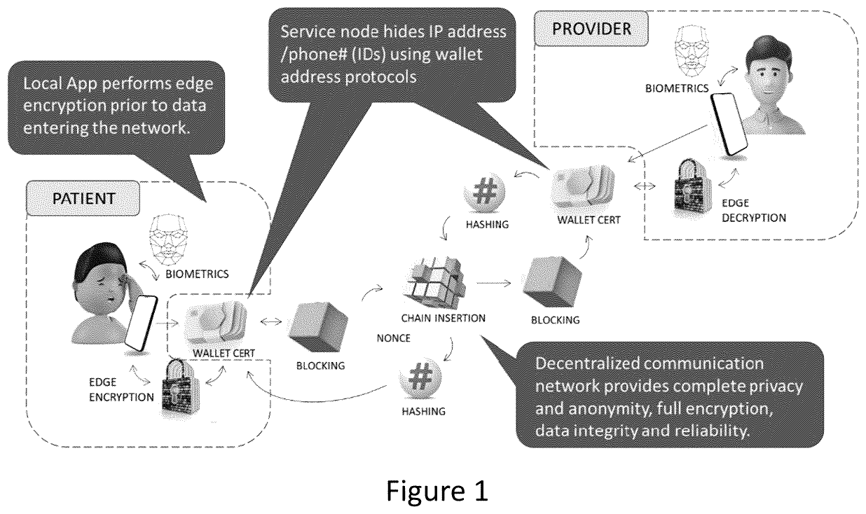

### DETAILED DESCRIPTION

One or more implementations of the present application provide a blockchain implemented secure contract communication method, to resolve a problem, in the existing technology, of data breach or compromise of communication between service end points, channels, servers as well as transitional data held in any communication network device.

One or more implementations of the present application provide a blockchain node communications apparatus, to resolve a problem, in the existing technology, of privacy data leakage that may be caused when service nodes in a blockchain network perform communication.

The following technical solutions are used in the implementations of the present application: A secure communication method is provided. Secure messaging systems in the prior art have integrated cryptocurrency and other blockchain technologies into their platforms, the focus has been on enhancing Decentralized Finance (DeFi) functionalities other than privacy. In this application we disclose systems methods and apparatus that employ blockchain technology in a unique way resulting in unexpected and highly desirable results. The technology disclosed herein includes a decentralized communication system, method and apparatus to and provide complete privacy and anonymity for secure communications where a preferred embodiment is illustrated in terms of a medical messaging platform.

The new technology disclosed herein uses a Service Node blockchain to hide IP addresses of users and data repositories on wired and wireless networks allowing to them to exchange messages without needing phone numbers or IP addresses. The new technology disclosed herein, runs on the common systems such as (but not limited to) Hyperlink Burrow blockchain (IBM/EVM) and solves the metadata problem by allowing users to communicate solely through preset cryptocurrency wallet address protocols. This allows for the use of a pre-distributed data channels with full ethernet 10/100, WiFi 7 and 4/5G data speeds, end to end encryption (data remains fully encrypted at rest), End point access is locked via biometrics (finger/face) as well as traditional multifactor authentication.

The new technology disclosed herein maintains encryption of all data (even data at rest/storage), maintains data integrity and distinctively protects private information and user anonymity through an innovative application of deployed blockchain addressing.

The new technology disclosed herein supports:
Secure data in locality, transport, storage and remote access
sub second data access via AWS infrastructure

Local data encryption time dependent on data size and mobile device however, encryption on data capture minimizes effective encryption time, latency and memory requirements.

Data is gathered raw but can be formatted into any standard format.

Supports MS Azure using IBM's Hyperscale Burrow (consider AWS for HIPPA scale deployment)

Uses a series of decentralized—centralized server cluster.

Blockchain nodes in a blockchain network include a service node. The service node stores a certificate sent by a certificate authority (CA), and is pre-configured with a CA trust list. The method includes: receiving, by a first blockchain node, a communication request sent by a second blockchain node, where the communication request includes a wallet certificate of the second blockchain node; determining a CA identifier that corresponds to the second certificate; determining whether the determined CA identifier that corresponds to the wallet certificate is included in the CA trust list; and if yes, establishing a communication connection to the second blockchain node; or if no, skipping establishing the communication connection to the second blockchain node.

A blockchain node communications apparatus is provided, and the apparatus includes: a receiving module, configured to receive a communication request sent by a second blockchain node, where the communication request includes a wallet certificate of the second blockchain node; a determining module, configured to determine a CA identifier that corresponds to the second certificate; and a determining and execution module, configured to determine whether the determined CA identifier that corresponds to the wallet certificate is included in a CA trust list; and if yes, establish a communication connection to the second blockchain node; or if no, skip establishing the communication connection to the second blockchain node; where blockchain nodes in a blockchain network include a service node, and the service node stores a certificate sent by a CA, and is pre-configured with the CA trust list.

A blockchain node communications device is provided. The communications device includes one or more processors and a memory. The memory stores a program, and the program is executed by the one or more processors to perform the following steps: receiving, at a first blockchain node, a communication request sent by a second blockchain node, where the communication request includes a wallet certificate of the second blockchain node; determining a CA identifier that corresponds to the second certificate; determining whether the determined CA identifier that corresponds to the wallet certificate is included in a CA trust list; and if yes, establishing a communication connection to the second blockchain node; or if no, skipping establishing the communication connection to the second blockchain node; where blockchain nodes in a blockchain network include a service node, and the service node stores a certificate sent by a CA, and is pre-configured with the CA trust list.

The one or more technical solutions used in the one or more implementations of the present application can achieve the following beneficial effects: A service node in a blockchain network stores a certificate sent by a CA, and is pre-configured with a CA trust list. When receiving the communication request sent by the second blockchain node, the first blockchain node can first determine, based on the wallet certificate of the second blockchain node that is included in the communication request, the CA identifier that corresponds to the second certificate, and then determine whether the CA identifier that corresponds to the wallet certificate is included in the CA trust list. If yes, the first blockchain node establishes the communication connection to the second blockchain node; or if no, the first blockchain node does not establish the communication connection to the second blockchain node. According to the method provided in the implementations of the present application, before establishing a communication connection, the service node in the blockchain network can determine whether to establish the communication connection based on the pre-configured CA trust list and a certificate that is included in a communication request, so that a possibility of leaking privacy data by the service node can be reduced by limiting an object (for example, another service node) to which the service node can establish the communication connection, and security of data stored in the blockchain network can be improved.

In some implementations, steps may be performed after the approval by the first node before the communication session is established. For example, the second node that have initiated the communication request may also wish to perform a reciprocal identity verification of the first node prior to establishing the communication session between the two nodes. Such mutual verification of identity may improve overall security of the blockchain network. As such, in some implementations, the second node comprises a second CA trust list comprising a plurality of CA identifiers, and approving, by the first node, the communication request comprises: transmitting, by the first node to the second node, a verification request comprising a public key certificate of the first node. The verification request, for example, can be transmitted in accordance with communication protocols such as the TLS or SSL protocol. In such implementations, the method further comprises: determining, by the second node, a second CA identifier from the received public key certificate of the first node; determining whether the second CA identifier matches one of the plurality of CA identifiers of the second CA trust list of the second node; in response to determining that the second CA identifier matches one of the plurality of CA identifiers of the second CA trust list, establishing a communication session with the first node; and in response to determining that the second CA identifier does not match one of the plurality of CA identifiers of the second CA trust list, denying, by the second node, establishment of the communication session with the first node.

The methods and apparatuses disclosed herein can improve security of a blockchain network by mitigating security threats posed by dubious or malicious Cas or tracking of IP addresses. By denying establishment of communication sessions with nodes whose identities are not certified by a trusted CA, security of the nodes of a consortium blockchain can be improved over nodes that do not utilize a CA trust list. Further, performance of the blockchain network implementing the disclosed methods and apparatuses may be superior to performance of conventional blockchains due to the reduced processing time associated with verification of the chain of trust of a public key certificate.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example, an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

In one embodiment, a computer-implemented method improves security of a communications network. A communications node of the blockchain network obtains a communications certificate authority trust list. The communications certificate authority trust list comprises a plurality of certificate authority identifiers. The communications node from a wallet node of a financial network receives a communication request comprising a public key certificate of the wallet node. The communications node of the blockchain network obtains a communications certificate authority identifier from the received public key certificate of the wallet node of the blockchain network. The communications node of the blockchain network determines that the communications certificate authority identifier matches one of the plurality of certificate authority identifiers of the communications certificate authority trust list. In response to determining that the communications certificate authority identifier matches one of the plurality of certificate authority identifiers of the communications certificate authority trust list, the communications node of the blockchain network approves the communication request. The approval comprises transmitting, by the communications node of the blockchain network and to the wallet node of the blockchain network, a verification request comprising a public key certificate of the communications node. The wallet node comprises a wallet certificate authority trust list comprising a plurality of certificate authority identifiers. The wallet node determines a wallet certificate authority identifier from the received public key certificate of the communications node. The wallet certificate authority identifier matches one of the plurality of certificate authority identifiers of the wallet certificate authority trust list of the wallet node. In response to determining that the wallet certificate authority identifier matches one of the plurality of certificate authority identifiers of the wallet certificate authority trust list, the communications node establishes a communication session.

The previous description of the embodiments is provided to enable any person skilled in the art to practice the disclosure. Thus, the present disclosure is not intended to be limited to the embodiments shown herein, but is to be accorded the widest scope consistent with the principles and features disclosed herein.

What is claimed is:

1. A blockchain contract system in a blockchain network comprising:
a financial network wallet node configured to receive a communication request comprising a public key certificate of a wallet node of the blockchain network, the financial network wallet mode stores a wallet certificate authority trust list comprising a plurality of certificate authority identifiers;
a blockchain network communications node configured to obtain a communications certificate authority trust list;
the blockchain network communications node is further configured to determine whether the communications certificate authority identifier matches one of the plurality of certificate authority identifiers of the communications certificate authority trust list;
when the blockchain network communications node determines that the communications certificate authority identifier matches one of the plurality of certificate authority identifiers of the communications certificate authority trust list, the blockchain network communications node approves a communication request, the approval of the communications request comprising:
transmitting, by the blockchain network communications node, to the blockchain network wallet a verification request comprising a public key certificate of the communications node;
the financial network wallet node verifies a wallet certificate authority identifier from the received public key certificate of the blockchain network communications node;
when the wallet certificate authority identifier matches one of the plurality of certificate authority identifiers of the wallet certificate authority trust list of the wallet node, the communications node establishes a communication session.

2. A blockchain contract method comprising:
receiving a communication request, via a financial network wallet node, the communication request comprising a public key certificate of a wallet node of the blockchain network;
storing, via the financial network wallet mode, a wallet certificate authority trust list comprising a plurality of certificate authority identifiers;
obtaining, via a blockchain network communications node, a communications certificate authority trust list;
determining, via the blockchain network communications node, whether the communications certificate authority identifier matches one of the plurality of certificate authority identifiers of the communications certificate authority trust list;
when the blockchain network communications node determines that the communications certificate authority identifier matches one of the plurality of certificate authority identifiers of the communications certificate authority trust list, the blockchain network communications node approves a communication request, the approval of the communications request comprising:
transmitting, by the blockchain network communications node, to the blockchain network wallet a verification request comprising a public key certificate of the communications node;
the financial network wallet node verifies a wallet certificate authority identifier from the received public key certificate of the blockchain network communications node;
when the wallet certificate authority identifier matches one of the plurality of certificate authority identifiers of the wallet certificate authority trust list of the wallet node, the communications node establishes a communication session.

3. A non-transitory computer-readable storage medium encoded with data and instructions, when read by a computing device causes a blockchain network to:
receive a communication request, via a financial network wallet node, the communication request comprising a public key certificate of a wallet node of the blockchain network;
store, via the financial network wallet mode, a wallet certificate authority trust list comprising a plurality of certificate authority identifiers;
obtain, via a blockchain network communications node, a communications certificate authority trust list;
determine, via the blockchain network communications node, whether the communications certificate authority identifier matches one of the plurality of certificate authority identifiers of the communications certificate authority trust list;
when the blockchain network communications node determines that the communications certificate authority identifier matches one of the plurality of certificate authority identifiers of the communications certificate authority trust list, the blockchain network communications node approves a communication request, the approval of the communications request comprising:
transmitting, by the blockchain network communications node, to the blockchain network wallet a verification request comprising a public key certificate of the communications node;
the financial network wallet node verifies a wallet certificate authority identifier from the received public key certificate of the blockchain network communications node;
when the wallet certificate authority identifier matches one of the plurality of certificate authority identifiers of the wallet certificate authority trust list of the wallet node, the communications node establishes a communication session.
